(19) United States
(12) Patent Application Publication
(10) Pub. No.: US 2019/0392169 A1
(43) Pub. Date: Dec. 26, 2019

(54) INFORMATION PROVIDING APPARATUS, INFORMATION PROVIDING SYSTEM, INFORMATION PROVIDING METHOD, AND COMPUTER READABLE MEDIUM

(71) Applicant: Mitsubishi Electric Corporation, Tokyo (JP)

(72) Inventors: Takumi MORI, Tokyo (JP); Mitsuhiro HATTORI, Tokyo (JP); Rina SHIMIZU, Tokyo (JP); Masahiro ITO, Tokyo (JP); Ryo FURUYA, Tokyo (JP); Kengo RYU, Tokyo (JP)

(73) Assignee: Mitsubishi Electric Corporation, Tokyo (JP)

(21) Appl. No.: 16/466,998

(22) PCT Filed: Jan. 30, 2017
(86) PCT No.: PCT/JP2017/003132

§ 371 Date: Jun. 5, 2019

(51) Int. Cl. G06F 21/62

(52) U.S. Cl. CPC G06F 21/6245

(57) ABSTRACT

In an information providing apparatus, a rule storage unit stores a processing rule including, as a permitted processing method, a processing method permitted for equipment information transmitted from equipment. Further, a data provision unit acquires a provision request including a processing method of the equipment information as a requested processing method. When the requested processing method matches the permitted processing method included in the processing rule, a data processing unit processes the equipment information by the requested processing method. Further, the data provision unit transmits, as processed information, the processed equipment information to a request source of the provision request.

### TECHNICAL FIELD

The present invention relates to an information providing apparatus, an information providing system, an information providing method, and an information providing program.

### BACKGROUND ART

In recent years, a concept of internet of things (IoT) has been proposed as a mechanism for mutual control by things being connected to the Internet and exchanging information. In this IoT, information collected from enormous objects is called big data, and its utilization is expected. However, big data may include personal information. Utilizing this personal information requires agreement on use permission from a provider of the personal information.

Patent Literatures illustrated below are disclosed as a mechanism for efficiently acquiring use permission for personal information.

Patent Literature 1 discloses an apparatus provided between a provider who provides personal information and a company that utilizes the personal information, that is, a service provider, for acquiring use permission for the personal information necessary for providing a service, by performing easily-understandable display of the use permission.

Further, Patent Literature 2 discloses a method that eliminates necessity of permission, by anonymizing provided personal information and making it non-personal information.

In addition, Patent Literature 3, Patent Literature 4, and Patent Literature 5 disclose a mechanism for storing a utilization history of personal information and checking a provision history by a provider of the personal information, in order to confirm whether the provision of personal information is appropriately performed.

### CITATION LIST

### Patent Literature

Patent Literature 1: JP 2015-049772 A

Patent Literature 2: JP 2016-186783 A

Patent Literature 3: JP 2008-217658 A

Patent Literature 4: JP 2005-202577 A

Patent Literature 5: JP 2006-344156 A

### SUMMARY OF INVENTION

### Technical Problem

In the method disclosed in Patent Literature 1, personal information is provided in accordance with use permission. However, once data is provided, it is not possible to grasp how the data is processed, secondarily used, and tertiarily used afterwards.

In addition, in the method disclosed in Patent Literature 2, by anonymizing personal information, it becomes difficult to provide feedback to individuals who are providers of the personal information in services using the personal information. Therefore, it is not a preferable method from the viewpoint of effective utilization of personal information.

Further, in the methods disclosed in Patent Literature 3, Patent Literature 4, and Patent Literature 5, when providing personal information itself, it is not possible to grasp what kind of statistical processing or utilization will be performed on the personal information after the provision. Therefore, it is not possible to guarantee whether the personal information is securely handled within a range of use permission.

Furthermore, information itself collected as big data is not personal information at first glance, but information on privacy may be obtained by applying statistical processing to the big data. In conventional techniques, since attention is focused only on personal information, consideration to such privacy information is not appropriately made.

An object of the present invention is to guarantee that information is securely handled within a range of use permission, by processing information on the basis of use permission for the information and providing only the processed information.

### Solution to Problem

An information providing apparatus according to the present invention includes:

a rule storage unit to store a processing rule including, as a permitted processing method, a processing method permitted for equipment information transmitted from equipment; and

a provision unit to acquire a provision request requesting processing and providing of the equipment information, the provision request including a processing method of the equipment information as a requested processing method, process the equipment information by the requested processing method when the requested processing method matches the permitted processing method included in the processing rule, and transmit the equipment information as processed information to a request source of the provision request.

### Advantageous Effects of Invention

In the information providing apparatus according to the present invention, a rule storage unit stores a processing rule including, as a permitted processing method, a processing method that is permitted for equipment information transmitted from equipment. Further, a provision unit acquires a provision request including a processing method of the equipment information as a requested processing method, and processes the equipment information by the requested processing method when the requested processing method matches the permitted processing method included in the processing rule. Further, the provision unit transmits the processed equipment information as processed information, to a request source of the provision request. Therefore, according to the information providing apparatus of the present invention, it is possible to provide only the information processed in accordance with the use permission for the information, and to guarantee that the information is securely handled within a range of the use permission.

### BRIEF DESCRIPTION OF DRAWINGS

FIG. 1 is a configuration diagram of an information providing system 500 according to a first embodiment.

FIG. 2 is a configuration diagram of equipment 20 according to the first embodiment.

FIG. 3 is a configuration diagram of an information providing apparatus 30 according to the first embodiment.

FIG. 4 is a configuration diagram of an information utilization apparatus 40 according to the first embodiment.

FIG. 5 is a configuration view of a utilization history 305 according to the first embodiment.

FIG. 6 is a flowchart illustrating an equipment information collection process S10 according to the first embodiment.

FIG. 7 is a flowchart illustrating a rule storage process S20 by the information providing apparatus 30 according to the first embodiment.

FIG. 8 is a view illustrating an example of a conversion definition 306 according to the first embodiment.

FIG. 9 is a view illustrating a specific example of a processing rule 302 according to the first embodiment.

FIG. 10 is a flowchart illustrating a providing process S30 according to the first embodiment.

FIG. 11 is a view illustrating a specific example of a provision request 303 according to the first embodiment.

FIG. 12 is a view illustrating a specific example of the utilization history 305 according to the first embodiment.

FIG. 13 is a flowchart illustrating a utilization history reference process S40 according to the first embodiment.

FIG. 14 is a view illustrating an operation example of the information providing system 500 according to the first embodiment.

FIG. 15 is a configuration diagram of equipment 20 according to a modification of the first embodiment.

FIG. 16 is a configuration diagram of an information providing apparatus 30 according to the modification of the first embodiment.

FIG. 17 is a configuration diagram of an information utilization apparatus 40 according to the modification of the first embodiment.

FIG. 18 is a view illustrating an operation example of an information providing system 500 according to a second embodiment.

### DESCRIPTION OF EMBODIMENTS

Hereinafter, embodiments of the present invention will be described with reference to the drawings. It should be noted that, in the individual drawings, the same or corresponding parts are denoted by the same reference numerals. In the description of the embodiments, the description of the same or corresponding parts will be omitted or simplified as necessary.

### First Embodiment

Description of Configuration

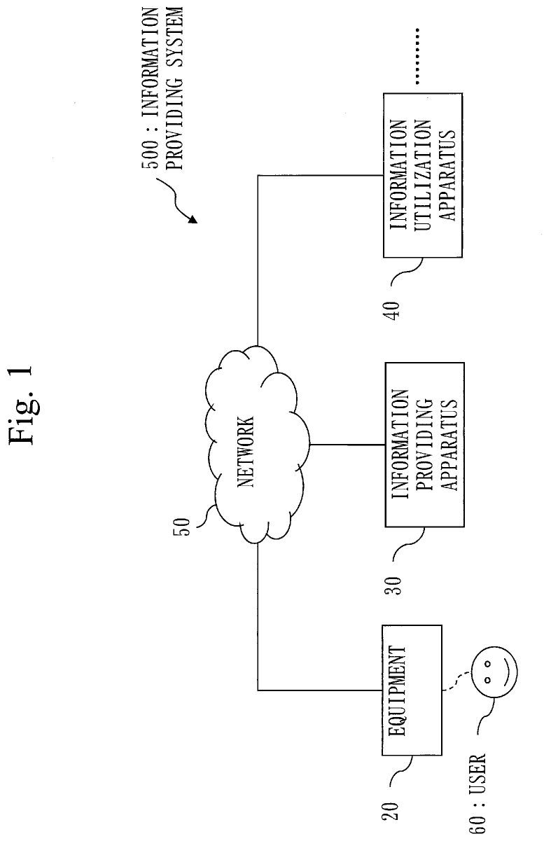

With reference to FIG. 1, a configuration of an information providing system 500 according to the present embodiment will be described.

The information providing system 500 includes equipment 20, an information providing apparatus 30, and an information utilization apparatus 40. The equipment 20, the information providing apparatus 30, and the information utilization apparatus 40 communicate with each other via a network 50.

The equipment 20 is equipment having a network communication function. The equipment 20 transmits operation data such as an operation history of the equipment 20, that is, equipment information generated by the equipment 20, to the information providing apparatus 30. For example, the equipment 20 is a household electric appliance compatible with a home energy management system (HEMS). Specifically, the equipment 20 is an air conditioner, a television, or a refrigerator. In a case where the equipment 20 is these household electric appliances, the equipment information transmitted to the information providing apparatus 30 is data such as an on/off status, a set temperature, or power consumption. Further, the equipment 20 may be equipment such as a camera or a sensor. In a case where the equipment 20 is a camera, photographic data photographed by the camera is transmitted as the equipment information. In a case where the equipment 20 is a sensor, the equipment information such as light, electromagnetic waves, a flow rate, magnetism, a temperature, or a humidity sensed by the sensor is transmitted. A user 60 is associated with the equipment 20 as an equipment owner, and permission of the user 60 is required to use the equipment information transmitted by the equipment 20.

The information providing apparatus 30 is a server device, and may be configured by a plurality of computers. The information providing apparatus 30 provides a data permission function as a service on the Internet. Further, the information providing apparatus 30 has functions of acquiring permission of the owner of the equipment 20, collecting equipment information from the equipment 20 via the network 50, processing the equipment information with a processing method to which the permission is obtained, and then providing the information to the information utilization apparatus 40. The information providing apparatus 30 is also referred to as a data permission device.

The information utilization apparatus 40 is a server device, and may be configured by a plurality of computers. The information utilization apparatus 40 provides a data utilization service as a service on the Internet. The data utilization service provided by the information utilization apparatus 40 is a service of utilizing big data. A specific example of the data utilization service is a service such as a watching system or a demand response using electricity consumption amount of household electric appliances. The information utilization apparatus 40 obtains data necessary for providing the data utilization service, from the information providing apparatus 30.

As a specific example, the network 50 is the Internet or a network constructed by a dedicated line.

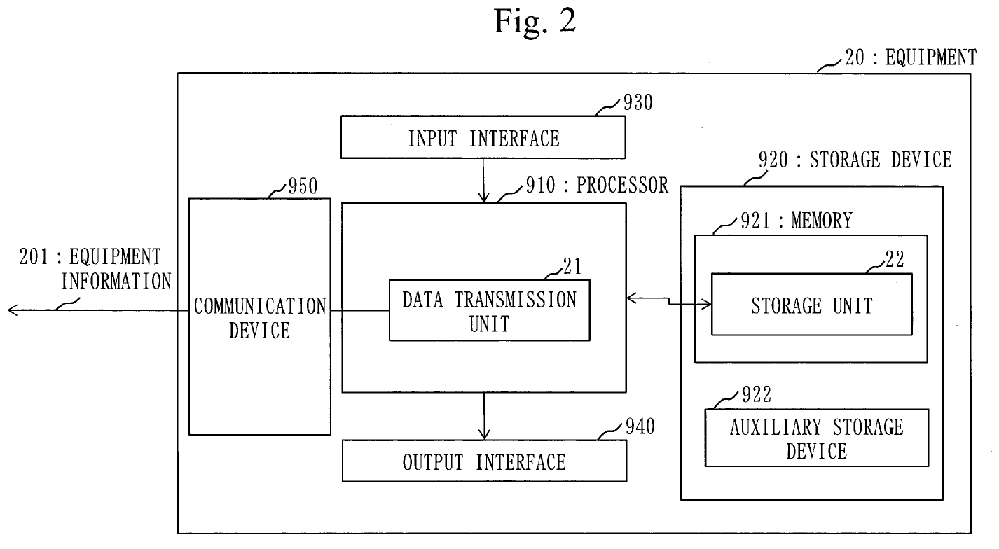

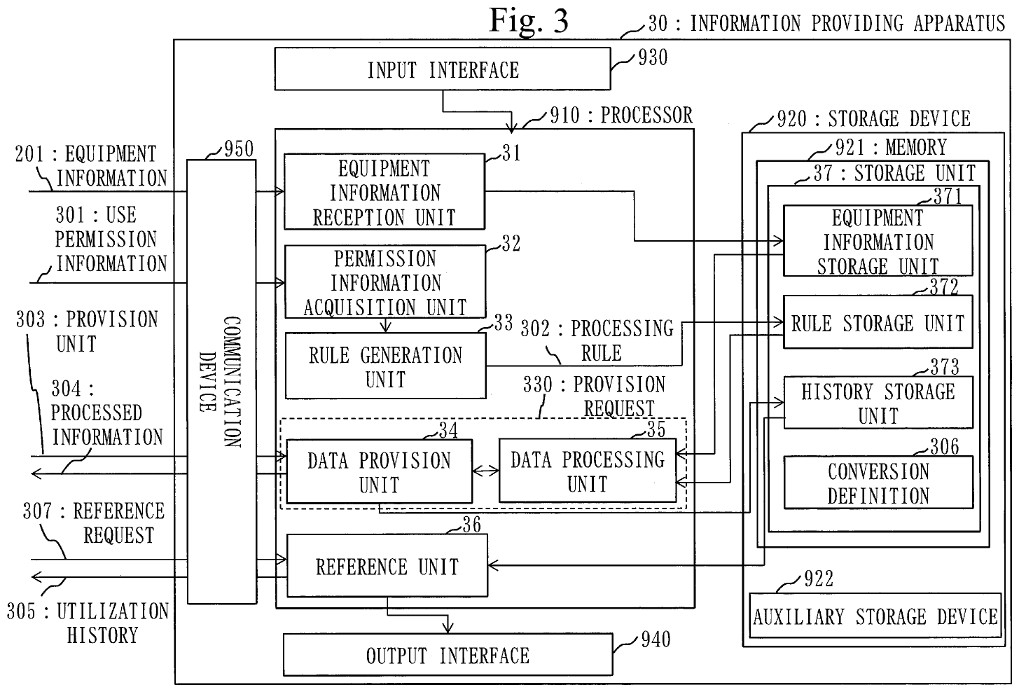

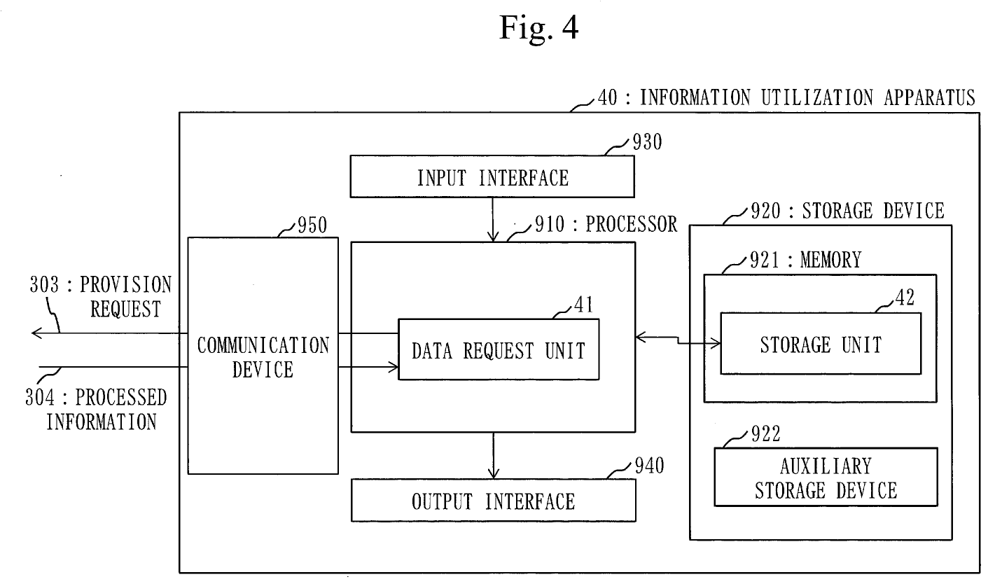

FIG. 2 is a configuration diagram of the equipment 20 according to the present embodiment. FIG. 3 is a configuration diagram of the information providing apparatus 30 according to the present embodiment. FIG. 4 is a configuration diagram of the information utilization apparatus 40 according to the present embodiment. Individual configurations of the equipment 20, the information providing apparatus 30, and the information utilization apparatus 40 will be described with reference to FIGS. 2 to 4. In the following description, each of the equipment 20, the information providing apparatus 30, and the information utilization apparatus 40 may be referred to as each device of the information providing system 500.

As illustrated in FIGS. 2 to 4, each of the equipment 20, the information providing apparatus 30, and the information utilization apparatus 40 is a computer.

Each device of the information providing system 500 includes hardware such as a processor 910, a storage device 920, an input interface 930, an output interface 940, and a communication device 950. The storage device 920 includes a memory 921 and an auxiliary storage device 922. Note that the hardware such as the processor 910, the storage device 920, the input interface 930, the output interface 940, and the communication device 950 is individually provided in each device of the information providing system 500, but the description is given with same reference numerals for the sake of simplicity of explanation.

The equipment 20 includes a data transmission unit 21 and a storage unit 22 as a functional configuration. The storage unit 22 stores equipment information 201 to be transmitted to the information providing apparatus 30.

A function of the data transmission unit 21 is realized by software.

The storage unit 22 is realized by the memory 921. Further, the storage unit 22 may be realized by only the auxiliary storage device 922, or by the memory 921 and the auxiliary storage device 922. The storage unit 22 may be realized by any method.

The information providing apparatus 30 includes an equipment information reception unit 31, a permission information acquisition unit 32, a rule generation unit 33, a provision unit 330, a reference unit 36, and a storage unit 37 as a functional configuration. The provision unit 330 includes a data provision unit 34 and a data processing unit 35. The storage unit 37 includes an equipment information storage unit 371, a rule storage unit 372, and a history storage unit 373.

Functions of the equipment information reception unit 31, the permission information acquisition unit 32, the rule generation unit 33, the data provision unit 34, the data processing unit 35, and the reference unit 36 are realized by software.

The storage unit 37 is realized by the memory 921. Further, the storage unit 37 may be realized by only the auxiliary storage device 922, or by the memory 921 and the auxiliary storage device 922. The storage unit 37 may be realized by any method.

The information utilization apparatus 40 includes a data request unit 41 and a storage unit 42 as a functional configuration.

A function of the data request unit 41 is realized by software.

The storage unit 42 is realized by the memory 921. Further, the storage unit 42 may be realized by only the auxiliary storage device 922, or by the memory 921 and the auxiliary storage device 922. The storage unit 42 may be realized by any method.

Note that the data transmission unit 21 of the equipment 20; the equipment information reception unit 31, the permission information acquisition unit 32, the rule generation unit 33, the data processing unit 35, the data provision unit 34, and the reference unit 36 of the information providing apparatus 30; and the data request unit 41 of the information utilization apparatus 40 may be referred to as each unit of each device.

The processor 910 is connected to other pieces of hardware via a signal line, and controls these other pieces of hardware. The processor 910 is an integrated circuit (IC) that performs arithmetic processing. As a specific example, the processor 910 is a central processing unit (CPU), a digital signal processor (DSP), or a graphics processing unit (GPU).

The memory 921 is a storage device that temporarily stores data. As a specific example, the memory 921 is a static random access memory (SRAM) or a dynamic random access memory (DRAM).

The auxiliary storage device 922 is a storage device that stores data. As a specific example, the auxiliary storage device 922 is a hard disk drive (HDD). In addition, the auxiliary storage device 922 may be a portable storage medium such as a secure digital (SD, registered trademark) memory card, a compact flash (CF), a NAND flash, a flexible disk, an optical disk, a compact disk, a Blu-Ray (registered trademark) disk, or a digital versatile disk (DVD).

The input interface 930 is a port connected to input devices such as a mouse, a keyboard, and a touch panel. Specifically, the input interface 930 is a universal serial bus (USB) terminal. Note that the input interface 930 may be a port connected to a local area network (LAN).

Moreover, the equipment 20 may be a household electric appliance, a sensor, a car, or the like, and may not have a keyboard or a mouse in some cases. Instead, a touch panel may be mounted on a display.

The output interface 940 is a port to be connected with a cable of a display device such as a display. Specifically, the output interface 940 is a USB terminal or a high-definition multimedia interface (HDMI) (registered trademark) terminal. Specifically, the display is a liquid crystal display (LCD).

The communication device 950 communicates with other devices via a network.

The communication device 950 has a receiver and a transmitter. The communication device 950 is connected to a communication network such as a LAN, the Internet, or a telephone line in a wired or wireless manner. Specifically, the communication device 950 is a communication chip or a network interface card (NIC). The communication device 950 is a communication unit that communicates data. The receiver is a reception unit that receives data. The transmitter is a transmission unit that transmits data.

The auxiliary storage device 922 stores an operating system (OS), a program group, and a file group.

The auxiliary storage device 922 stores a program for realizing a function of each unit of each device. A program for realizing a function of each unit of each device is also referred to as an information providing program 620. This program is loaded into the memory 921, read by the processor 910, and executed by the processor 910. Further, at least a part of the OS stored in the auxiliary storage device 922 is loaded into the memory 921. The processor 910 executes the information providing program 620 while executing the OS.

Each device of the information providing system 500 may include only one processor 910 or may include a plurality of processors 910. The plurality of processors 910 may cooperatively execute a program for realizing a function of each unit of each device.

Information, data, a signal value, and a variable value that indicate a processing result of each unit of each device are stored in the auxiliary storage device 922, the memory 921, or a register or a cache memory in the processor 910 of each device.

The program for realizing a function of each unit of each device may be stored in a portable recording medium. Specifically, the portable recording medium is a magnetic disk, a flexible disk, an optical disk, a compact disk, a Blu-ray (registered trademark) disk, and a digital versatile disk (DVD).

Note that an information providing program product is a storage medium and a storage device in which the information providing program 620 is recorded. The information providing program product refers to what is loaded with a computer readable program regardless of appearance.

Description of Function

Next, a function of the equipment 20 illustrated in FIG. 2 will be described.

The equipment information 201 is data generated in the equipment 20. Specifically, the equipment information 201 is information obtained from various sensors included in the equipment 20, or information such as a history of operation by the owner of the equipment 20.

The data transmission unit 21 transmits the equipment information 201 to the information providing apparatus 30 via the communication device 950.

Next, a function of the information providing apparatus 30 illustrated in FIG. 3 will be described.

Use permission information 301 is information indicating permission for utilization of the equipment information 201, by the user 60 who is the owner of the equipment 20. Specifically, the use permission information 301 is information such as a use application of data, a providing destination of data, a data type, a data range, a processing method, and a reference frequency.

A processing rule 302 includes a processing method permitted for the equipment information 201 transmitted from the equipment 20, as a permitted processing method. The processing rule 302 is information including a data processing method at a time of providing the equipment information 201 to the information utilization apparatus 40, as a permitted processing method. Specifically, the processing rule 302 is information such as: a statistical analysis method such as averaging, dispersion, or standard deviation; a use application of data; a providing destination of data; a type of data that can be provided; and a data expiration date.

A provision request 303 requests processing and providing of the equipment information 201. Further, the provision request 303 includes a processing method of the equipment information 201 as a requested processing method. That is, the provision request 303 is information for requesting the equipment information 201 subjected to processing according to a specific purpose, for the equipment information 201 stored in the information providing apparatus 30. The processing according to a specific purpose is the requested processing method, which specifically is processing such as averaging, dispersion, or standard deviation. The provision request 303 includes information such as: an identifier of the user 60 who is the owner of the equipment information 201; an identifier or a service type of the information utilization apparatus 40 that is a request source; a use application of data; a type of data desired to be acquired; a data range; and a statistical value desired to be acquired. The data range is information such as a period in a case of time-series data. In the following, the request source of the provision request 303 is a request source that requests provision of processed information 304. Specifically, the request source is a transmission source of the provision request 303.

The processed information 304 is data obtained by processing the equipment information 201 in accordance with the processing rule 302. The processed information 304 is the equipment information 201 processed by the requested processing method included in the provision request 303. Specifically, the processed information 304 is data obtained by applying statistical processing such as averaging, dispersion, or standard deviation, or processing of intentionally missing a part of data, on the equipment information 201.

A utilization history 305 is information indicating a history of utilizing the equipment information 201, such as provision date and time, a providing destination, a use application, a data processing method, and a reference frequency, at a time of providing the processed information 304 in response to the provision request 303. Utilizing the equipment information 201 means processing and providing of the equipment information 201.

The equipment information reception unit 31 receives the equipment information 201, and stores in the equipment information storage unit 371.

The equipment information storage unit 371 stores the equipment information 201 received by the equipment information reception unit 31.

The permission information acquisition unit 32 acquires the use permission information 301 indicating a permission condition, which is a permission condition permitted for the equipment information 201, including a processing method permitted for the equipment information 201. The permission information acquisition unit 32 acquires the use permission information 301 and outputs to the rule generation unit 33.

The rule generation unit 33 generates the processing rule 302 on the basis of the use permission information 301, and stores in the rule storage unit 372. Specifically, the rule generation unit 33 acquires the use permission information 301 from the permission information acquisition unit 32, and generates the processing rule 302 according to the use permission. Specifically, the rule generation unit 33 defines in advance a data processing method corresponding to the use permission, and generates the processing rule 302 in accordance with the definition. Specific examples are described in the description of an operation.

The rule storage unit 372 stores the processing rule 302 including, as a permitted processing method, a processing method permitted for the equipment information 201 transmitted from the equipment 20. The rule storage unit 372 stores the processing rule 302 created by the rule generation unit 33.

The provision unit 330 acquires the provision request 303 including a processing method of the equipment information 201 as the requested processing method, and requesting for processing and providing of the equipment information 201. Then, when the requested processing method matches the permitted processing method included in the processing rule 302, the provision unit 330 processes the equipment information 201 by the requested processing method. Then, the provision unit 330 transmits the processed equipment information 201 as the processed information 304 to the request source of the provision request 303.

Further, the provision unit 330 generates a history of transmitting the processed information 304 to the request source of the provision request 303, as the utilization history 305.

Hereinafter, a function of each unit of the data provision unit 34 and the data processing unit 35 included in the provision unit 330 will be described.

The data provision unit 34 receives the provision request 303, acquires the processed information 304 from the data processing unit 35, and stores a history related to the processed information 304 in the history storage unit 373 as the utilization history 305. The data provision unit 34 stores the utilization history 305 of the equipment information 201 in conjunction with the processing of the equipment information 201.

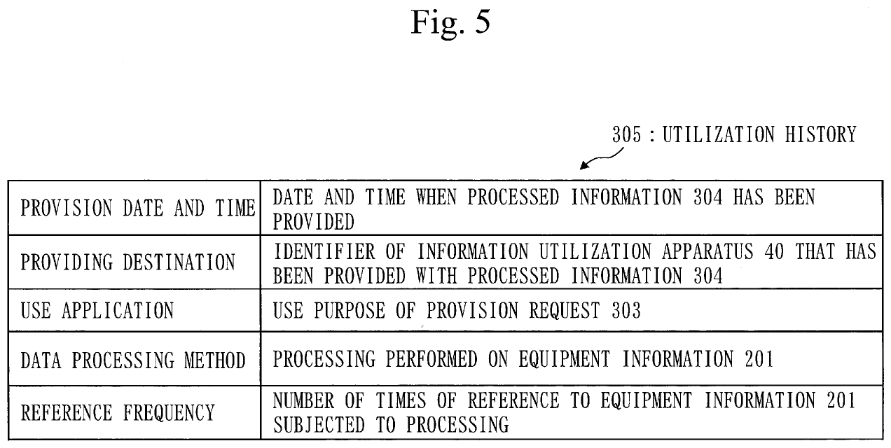

With reference to FIG. 5, a configuration of the utilization history 305 according to this embodiment will be described.

The utilization history 305 has items of provision date and time, a providing destination, a use application, a data processing method, and a reference frequency. In the provision date and time, the date and time when the processed information 304 has been provided is recorded. In the providing destination, an identifier of the information utilization apparatus 40 that has been provided with the processed information 304 is recorded. For the use application, a use purpose of the provision request 303 is recorded. In the data processing method, processing performed on the equipment information 201 is recorded. In the reference frequency, the number of times of reference to the equipment information 201 subjected to the processing is recorded.

The data processing unit 35 acquires the provision request 303 from the data provision unit 34, and retrieves the processing rule 302 corresponding to the request, from the rule storage unit 372. Next, in accordance with the retrieved processing rule 302, the data processing unit 35 processes the equipment information 201 stored in the equipment information storage unit 371, and generates the processed information 304. Finally, the data processing unit 35 outputs the generated processed information 304 to the data provision unit 34.

The history storage unit 373 stores the utilization history 305 generated by the provision unit 330. The history storage unit 373 stores the utilization history 305 generated by the data provision unit 34.

The reference unit 36 acquires a reference request 307 requesting reference to the utilization history 305, and extracts the utilization history 305 from the history storage unit 373 on the basis of the reference request 307. The reference unit 36 transmits the extracted utilization history 305 to the request source of the reference request 307. That is, the reference unit 36 discloses the utilization history 305 stored in the history storage unit 373 to the user 60.

Next, a function of the information utilization apparatus 40 illustrated in FIG. 4 will be described.

The information utilization apparatus 40 provides a service utilizing the processed equipment information 201, that is, the processed information 304. Note that any service may be adopted in the present embodiment, so that only a function necessary for acquiring the processed information 304 will be described without explaining a functional block for realizing the service.

The data request unit 41 transmits the provision request 303 requesting provision of the equipment information 201, to the information providing apparatus 30. Then, the data request unit 41 receives the processed information 304 according to the provision request 303.

Description of Operation

Next, processing of an information providing method 610 and the information providing program 620 of the information providing system 500 according to the present embodiment will be described. The information providing program 620 causes each device of the information providing system 500 to execute each process indicated below.

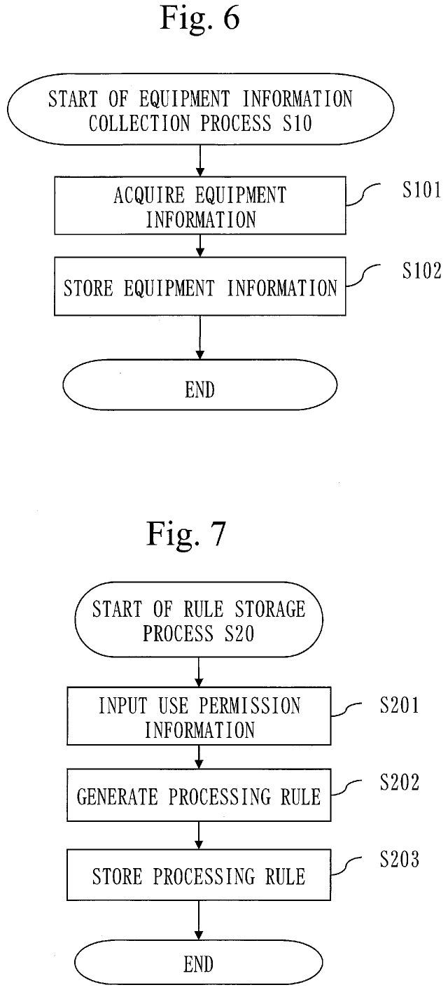

With reference to FIG. 6, an equipment information collection process S10 according to the present embodiment will be described. The equipment information collection process S10 is a process in which the information providing apparatus 30 collects the equipment information 201 from the equipment 20.

In step S101, the data transmission unit 21 of the equipment 20 transmits the equipment information 201 to the information providing apparatus 30 via the communication device 950. The data transmission unit 21 may periodically transmit the equipment information 201 to the information providing apparatus 30. Alternatively, the data transmission unit 21 may accumulate the equipment information 201 in the storage unit 22 of the equipment 20, and transmit the equipment information 201 of a predetermined data amount to the information providing apparatus 30.

In step S102, the equipment information reception unit 31 of the information providing apparatus 30 receives the equipment information 201 transmitted from the equipment 20, via the communication device 950. The equipment information reception unit 31 stores the equipment information 201 in the equipment information storage unit 371, in association with information of the owner of the equipment 20, that is, the user 60 who is the owner of the equipment information 201. Note that the equipment information reception unit 31 of the information providing apparatus 30 may request for the equipment information 201 to a specific equipment 20, and receive the equipment information 201 as a response to the request.

Next, with reference to FIG. 7, a rule storage process S20 by the information providing apparatus 30 according to the present embodiment will be described. The rule storage process S20 is a process in which the rule storage unit 372 stores the processing rule 302 including, as a permitted processing method, a processing method permitted for the equipment information 201 transmitted from the equipment 20.

In step S201, the permission information acquisition unit 32 acquires the use permission information 301 related to the equipment information 201 of the equipment 20, inputted by the user 60. A method of inputting the use permission information 301 by the user 60 is a method such as inputting from a form of a WEB page, inputting by an electronic file in a specific format, or inputting by e-mail.

In step S202, the rule generation unit 33 acquires the use permission information 301 acquired by the permission information acquisition unit 32. The rule generation unit 33 generates the processing rule 302 on the basis of the use permission information 301. A conversion method from the use permission information 301 to the processing rule 302 is defined in advance as the conversion definition 306, and the rule generation unit 33 converts in accordance with the conversion definition 306.

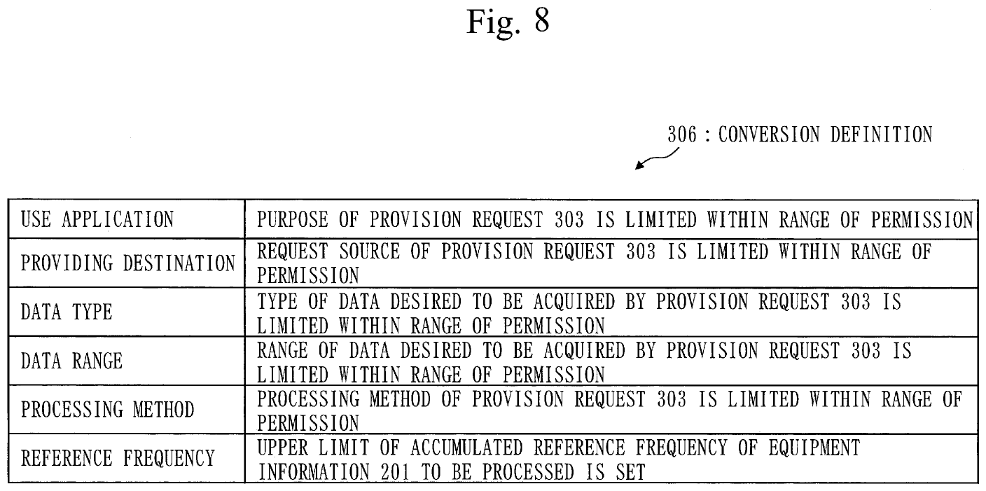

FIG. 8 is a view illustrating an example of the conversion definition 306 according to the present embodiment.

The conversion definition 306 defines conversion of the processing rule 302 from the use permission information 301 as follows. The conversion definition 306 is generated in advance and stored in the storage unit 37. Note that, as described above, the use permission information 301 includes a use application of data, a providing destination of data, a data type, a data range, a processing method, and a reference frequency.

The use application limits a purpose of the provision request 303 within a range of permission. The providing destination limits a request source of the provision request 303 within a range of permission. The data type limits a type of data desired to be acquired by the provision request 303 within a range of permission. The data range limits a range of data desired to be acquired by the provision request 303 within a range of permission. The processing method limits a processing method of the provision request 303 within a range of permission. The reference frequency sets an upper limit of an accumulated reference frequency of the equipment information 201 to be processed.

As a specific example, suppose that the rule generation unit 33 sets each of the use application, the providing destination, the data type, the data range, the processing method, and the reference frequency as follows, in the use permission information 301.

For the use application, a watching service and a demand response are set.

For the providing destination, a watching service A and a demand response service B are set.

For the data type, a power on/off status and a power consumption amount are set.

For the data range, from Jan. 1, 2016 to Dec. 31, 2018 is set.

For the processing method, an average, a maximum, and a minimum for each hour are set.

For the reference frequency, 1000 is set.

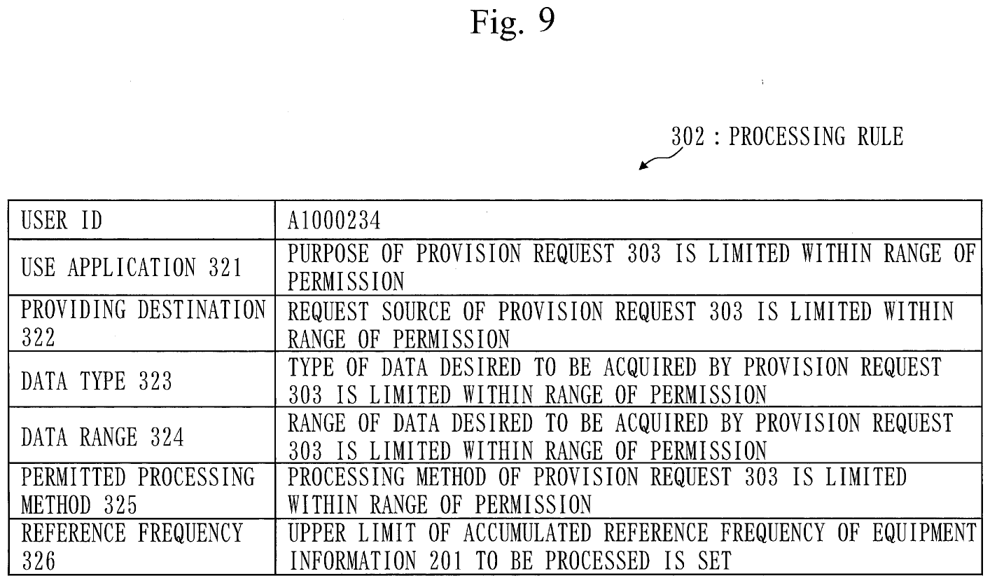

FIG. 9 is a view illustrating a specific example of the processing rule 302 according to the present embodiment. In a case of the specific example described above, the processing rule 302 is as illustrated in FIG. 9.

A use application 321 is limited to the watching service and the demand response.

A providing destination 322 is limited to the watching service A and the demand response service B.

A data type 323 can refer to only the power on/off status and the power consumption amount.

A data range 324 is from Jan. 1, 2016 to Dec. 31, 2018.

A permitted processing method 325 provides only an average, a maximum, and a minimum for each hour.

A reference frequency 326 is to be disabled with the accumulated reference frequency 1000 times.

Finally, in step S203, the rule generation unit 33 stores the generated processing rule 302 in the rule storage unit 372. The rule generation unit 33 stores the generated processing rule 302 in association with information of the user 60 who is the owner of the equipment 20 that has transmitted the equipment information 201. In FIG. 9, the identifier of the user 60 is set to a user ID “A1000234”, and is associated with the processing rule 302. Further, the processing rule 302 is configured to be able to be specified from the equipment information 201 stored in the equipment information storage unit 371. Specifically, the rule storage unit 372 is made into a database such that the processing rule 302 can be retrieved from information such as information of the user 60, a data type, or a data range.

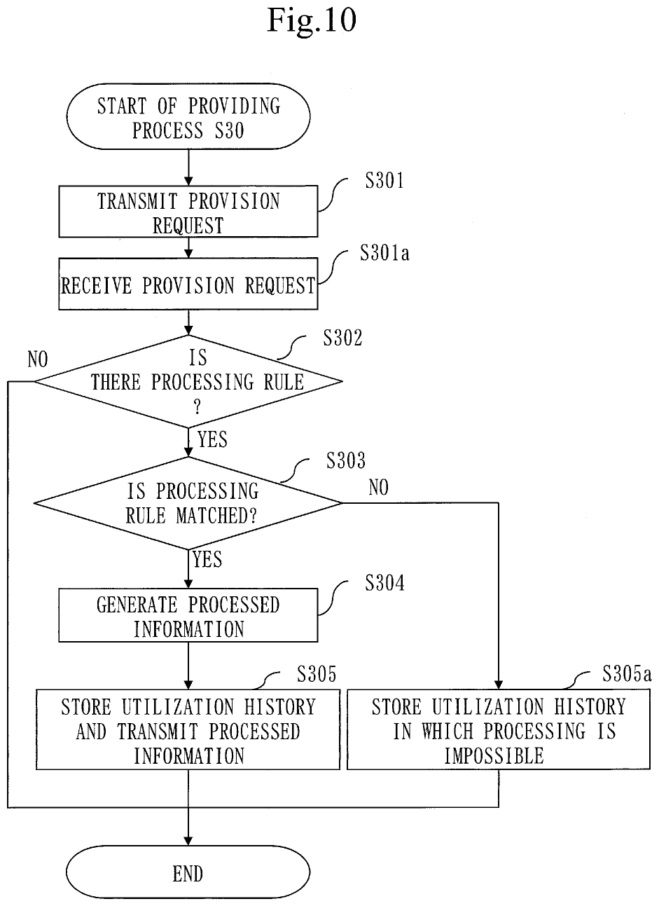

Next, with reference to FIG. 10, the providing process S30 according to the present embodiment will be described. In the providing process S30, the provision unit 330 acquires the provision request 303 including a processing method of the equipment information 201 as a requested processing method 336, and requesting processing and providing of the equipment information 201. Then, when the requested processing method 336 matches the permitted processing method 325 included in the processing rule 302, the provision unit 330 processes the equipment information 201 by the requested processing method 336. Then, the provision unit 330 transmits the equipment information 201 as the processed information 304 to the request source of the provision request 303.

In step S301, the data request unit 41 of the information utilization apparatus 40 generates the provision request 303. The data request unit 41 transmits the provision request 303 to the information providing apparatus 30 via the communication device 950.

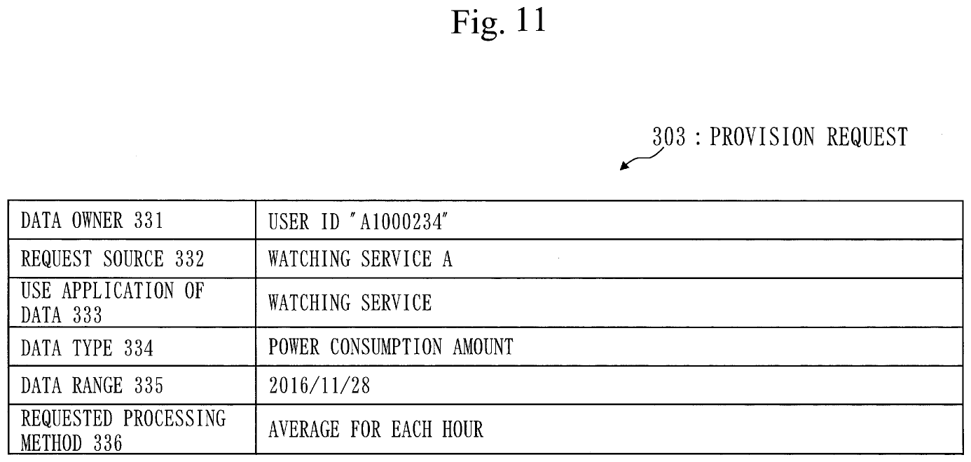

FIG. 11 is a view illustrating a specific example of the provision request 303 according to the present embodiment.

The provision request 303 includes information such as a data owner 331, a request source 332, a use application 333, a data type 334, a data range 335, and the requested processing method 336. Specific examples are as follows.

In the data owner 331, the user ID “A1000234” is set.

In the request source 332, the watching service A is set.

In the use application 333, the watching service is set.

In the data type 334, the power consumption amount is set.

In the data range 335, Nov. 28, 2016 is set.

In the requested processing method 336, that is, as a statistic value desired to be acquired, an average for each hour is set.

In step S301a, the data provision unit 34 of the information providing apparatus 30 receives the provision request 303 transmitted from the information utilization apparatus 40 via the communication device 950. The data provision unit 34 outputs the provision request 303 to the data processing unit 35.

In step S302, the data processing unit 35 searches the rule storage unit 372 for the processing rule 302 corresponding to the provision request 303. In a specific example of having received the provision request 303 of FIG. 11, the data processing unit 35 searches the rule storage unit 372 for the processing rule 302 related to the “power consumption amount” data of the user ID “A1000234”.

When there is the corresponding processing rule 302, the process proceeds to step S303.

When there is no corresponding processing rule 302, this means that the corresponding equipment information 201 does not exist or that use permission has not been obtained. Therefore, data provision unit 34 returns, to the information utilization apparatus 40, that the corresponding equipment information 201 does not exist or that use permission has not been obtained, but does not return the processed information 304.

In a specific example of having received the provision request 303 in FIG. 11, the data processing unit 35 acquires the processing rule 302 in FIG. 9 indicated below from the rule storage unit 372, in accordance with the provision request 303 in FIG. 11.

The use application 321 is limited to the watching service and the demand response.

The providing destination 322 is limited to the watching service A and the demand response service B.

The data type 323 can refer to only the power on/off status and the power consumption amount.

The data range 324 is from Jan. 1, 2016 to Dec. 31, 2018.

The permitted processing method 325 provides only an average, a maximum, and a minimum for each hour.

The reference frequency 326 is to be disabled with the accumulated reference frequency 1000 times.

In step S303, the data processing unit 35 determines whether or not the acquired processing rule 302 matches the provision request 303. When the processing rule 302 does not match the provision request 303, this means that data cannot be provided. When the processing rule 302 does not match the provision request 303, the process proceeds to step S305a.

In step S305a, the data provision unit 34 of the provision unit 330 generates a history in which generation of the processed information 204 has been impossible for the provision request 303 since the requested processing method 336 does not match the permitted processing method 325 included in the processing rule 302. Then, the data provision unit 34 includes a history in which generation of the processed information 204 has been impossible for the provision request 303 in the utilization history 305, and stores in the history storage unit 373. At this time, there is a possibility that the user 60 who is the owner of the equipment information 201 reconsiders the use permission in accordance with the history in which provision has been impossible. The data provision unit 34 may include the following information in the utilization history 305.

The request date and time is Nov. 29, 2016, that is, the date and time when the data request has been performed.

The request source is the watching service A.

The use application is the watching service.

The requested processing method that has been impossible is standard deviation for each hour.

Further, the data provision unit 34 returns that the processed equipment information 201 cannot be provided, to the information utilization apparatus 40 of the request source of the provision request 303.

Whereas, when the processing rule 302 matches the provision request 303, the process proceeds to step S304.

In step S304, the data processing unit 35 acquires the equipment information 201 corresponding to the processing rule 302, from the equipment information storage unit 371. In accordance with the processing rule 302, the data processing unit 35 processes the equipment information 201 acquired from the equipment information storage unit 371, and generates the processed information 304. The data processing unit 35 outputs the processed information 304 to the data provision unit 34.

A specific example of having received the provision request 303 of FIG. 11 will be described.

At this time, the processing rule 302 has been as follows.

The use application 321 is limited to the watching service and the demand response.

The providing destination 322 is limited to the watching service A and the demand response service B.

The data type 323 can refer to only the power on/off status and the power consumption amount.

The data range 324 is from Jan. 1, 2016 to Dec. 31, 2018.

The permitted processing method 325 provides only an average, a maximum, and a minimum for each hour.

The reference frequency 326 is to be disabled with the accumulated reference frequency 1000 times.

This processing rule 302 matches the provision request 303 in FIG. 11 below.

In the data owner 331, the user ID “A1000234” is set.

In the request source 332, the watching service A is set.

In the use application 333, the watching service is set.

In the data type 334, the power consumption amount is set.

In the data range 335, Nov. 28, 2016 is set.

In the requested processing method 336, that is, as a statistic value desired to be acquired, an average for each hour is set.

Accordingly, the data processing unit 35 calculates an average value for each hour for the equipment information 201 of Nov. 28, 2016, and sets the calculation result as the processed information 304.

In step S305, the data provision unit 34 creates the utilization history 305 for the equipment information 201, and stores in the history storage unit 373. Further, the data provision unit 34 transmits the processed information 304 to the information utilization apparatus 40 via the communication device 950. That is, the data provision unit 34 stores the utilization history 305 of the equipment information 201 in conjunction with the processing of the equipment information 201.

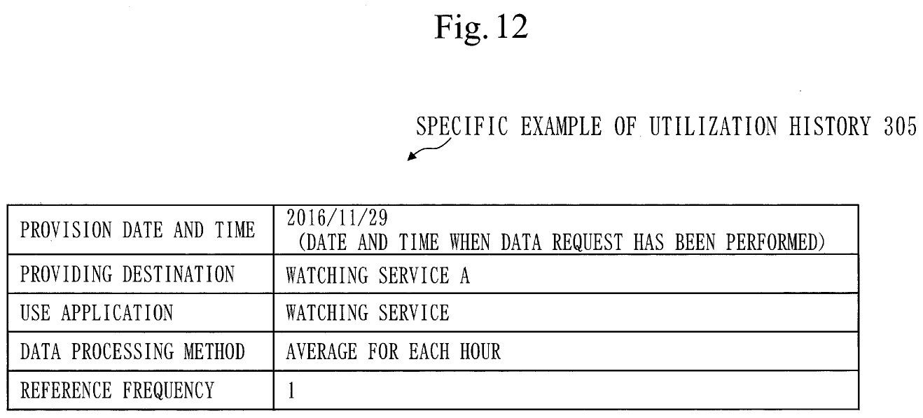

FIG. 12 is a view illustrating a specific example of the utilization history 305 according to the present embodiment.

In a specific example of having received the provision request 303 of FIG. 11, the utilization history 305 is as illustrated in FIG. 12.

In the provision date and time, Nov. 29, 2016, that is, the date and time when the provision request has been received is set.

In the providing destination, the watching service A is set.

In the use application, the watching service is set.

In the data processing method, an average for each hour is set.

In the reference frequency, 1 is set.

Note that, in a specific example of having received the provision request 303 in FIG. 11, the processing method of the equipment information 201 is set as an average for each hour, but the processing method is not limited to this. In addition, as long as it is a statistical method, a processing method such as dispersion, deviation, distribution, or verification may be adopted. Further, filtering of specific data, or an anonymization method of eliminating or reducing information specifying an individual may be used as a processing method. Anonymization methods include a method of pseudonymization of pseudonymizing identifiers of individuals, or obscuration of coarsening granularity of information by rounding processing.

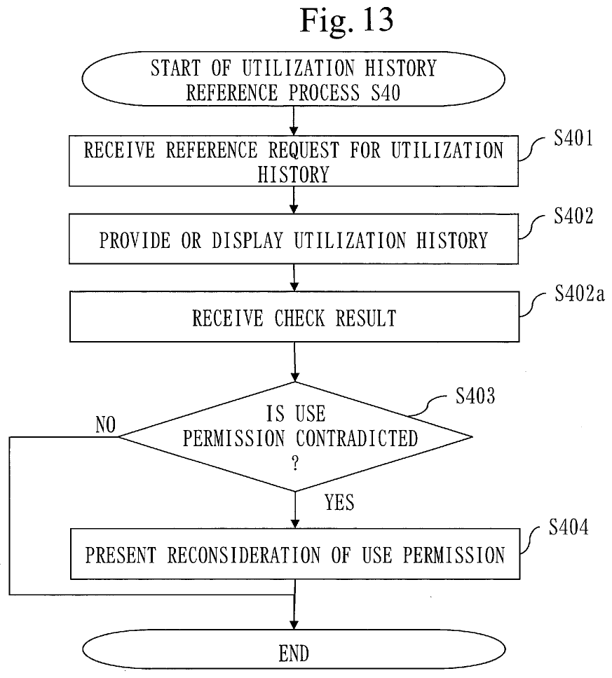

With reference to FIG. 13, the utilization history reference process S40 according to the present embodiment will be described.

In step S401, the reference unit 36 of the information providing apparatus 30 receives the reference request 307 for the utilization history 305 of the equipment information 201, from the user 60 who is the owner of the equipment 20. At this time, the reference unit 36 may perform identity authentication on the user 60. The reference unit 36 may acquire the reference request 307 for the utilization history 305 via the input interface 930. Alternatively, the reference unit 36 may acquire the reference request 307 for the utilization history 305 via the communication device 950.

In step S402, the reference unit 36 acquires the utilization history 305 corresponding to the equipment information 201 related to the equipment 20 of the user 60, from the history storage unit 373. The reference unit 36 presents the acquired utilization history 305 to the user 60. The reference unit 36 displays the utilization history 305 on a display via the output interface 940. Alternatively, the reference unit 36 transmits the utilization history 305 to the request source of the reference request 307 via the communication device 950.

Specifically, the reference unit 36 performs presentation to the user 60 by displaying the utilization history 305 on the display via the output interface 940. Alternatively, the reference unit 36 may transmit the utilization history 305 to the user 60 via the communication device 950. The user 60 checks whether or not the presented utilization history 305 contradicts an assumed use permission.

In step S402a, the reference unit 36 receives a check result by the user 60.

In step S403, the reference unit 36 determines whether or not the utilization history 305 contradicts the use permission, on the basis of the check result. When the utilization history 305 does not contradict the use permission, the checking of the utilization history 305 is terminated. When the utilization history 305 contradicts the use permission, the process proceeds to step S404.

In step S404, the reference unit 36 presents information recommending reconsideration of the use permission information 301, to the user 60.

Specifically, the reference unit 36 presents to the user 60, by displaying a screen recommending reconsideration of the use permission information 301 on the display. In a case where the user 60 reconsiders the use permission information 301 on the basis of the information recommending reconsideration of the use permission information 301, the permission information acquisition unit 32 acquires new use permission information 301 from the user 60, and updates the use permission information 301.

Further, when presenting the utilization history 305, the reference unit 36 may disclose, to the user 60, a history in which the provision request 303 has been received but not been provided due to contradiction with the use permission, and may prompt permission.

Furthermore, in order to comply with the law concerning personal information protection, the reference unit 36 may be used when an audit regarding the use of personal information is carried out. In a case of being pointed out in the audit regarding the use of personal information, an administrator of the information providing apparatus 30 may change the processing rule 302.

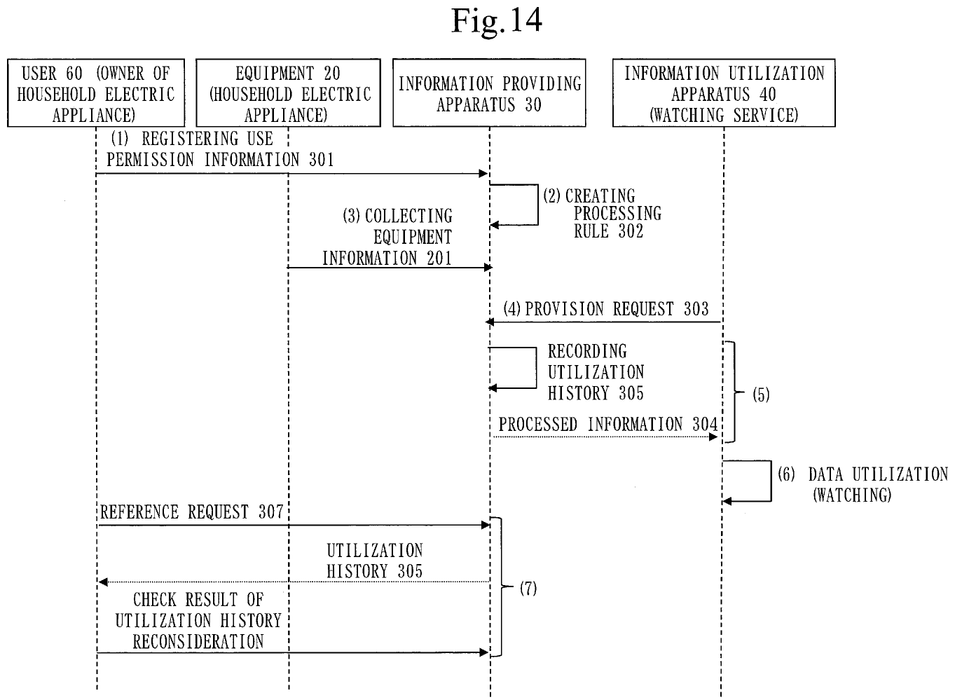

Next, with reference to FIG. 14, an example of a series of operations as the entire information providing system 500 according to the present embodiment will be described.

In the example of FIG. 14, the equipment 20 is a household electric appliance compatible with the HEMS. Further, the information utilization apparatus 40 provides a watching service.

(1) The user 60 who is the owner of the household electric appliance registers the use permission information 301 in the information providing apparatus 30.

(2) The information providing apparatus 30 creates the processing rule 302 from the use permission information 301, and stores. The processing of (1) and (2) corresponds to a processing rule storage process S20 in FIG. 7.

(3) The equipment information 201 is transmitted from the household electric appliance to the information providing apparatus 30, and stored in the information providing apparatus 30. The processing of (3) corresponds to the equipment information collection process S10 of FIG. 6.

(4) The watching service performs provision request for the equipment information 201, to the information providing apparatus 30.

(5) The information providing apparatus 30 processes the equipment information 201, records a utilization history thereof, and returns the processed information 304. The processing of (4) and (5) corresponds to the providing process S30 in FIG. 10.

(6) The watching service utilizes the acquired processed information 304 to realize the watching service.

(7) Finally, the user 60 who is the owner of the household electric appliance checks the utilization history 305 of the equipment information 201 provided by the owned household electric appliance, to the information providing apparatus 30. When there is such a problem that there is utilization contradicting an assumed use permission, the user 60 reconsiders the use permission. The processing of (7) corresponds to the utilization history reference process S40 of FIG. 13.

Thereafter, the information providing system 500 repeats the cycle from (1) to (7).

Other Configuration

Hereinafter, the data transmission unit 21 of the equipment 20; the equipment information reception unit 31, the permission information acquisition unit 32, the rule generation unit 33, the data processing unit 35, the data provision unit 34, and the reference unit 36 of the information providing apparatus 30; and the data request unit 41 of the information utilization apparatus 40 may be referred to as each unit of each device.

In the present embodiment, a function of each unit of each device is realized by software. However, as a modification, a function of each unit of each device may be realized by hardware.

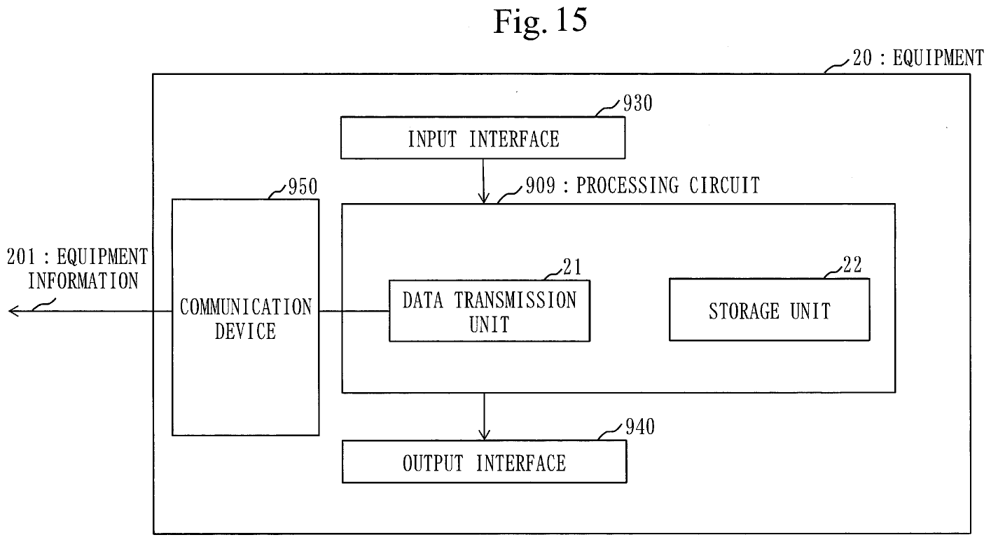

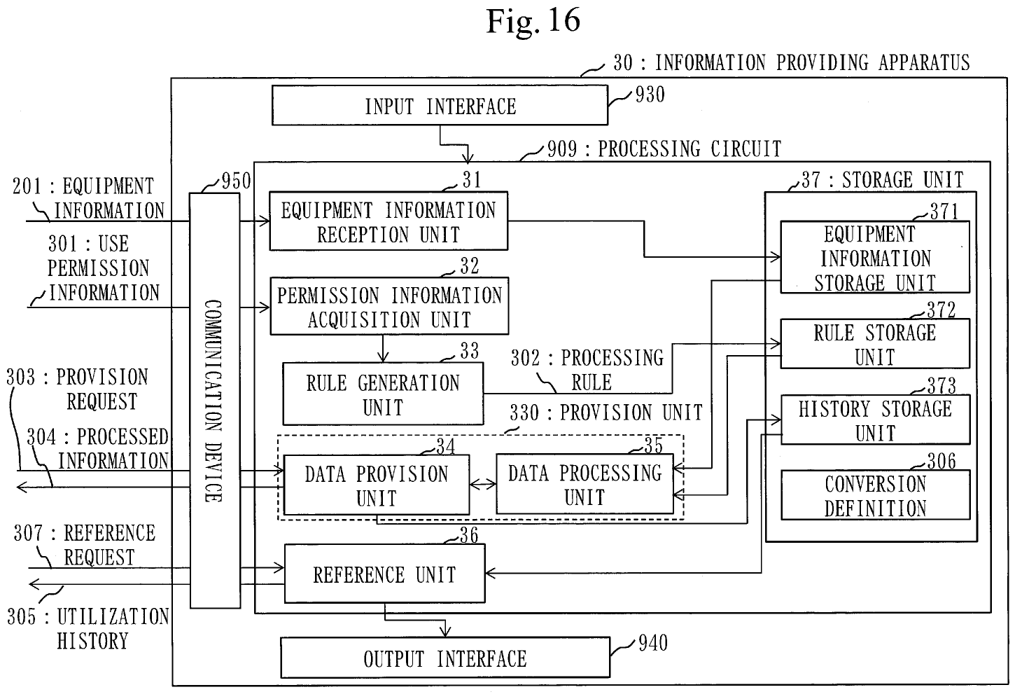

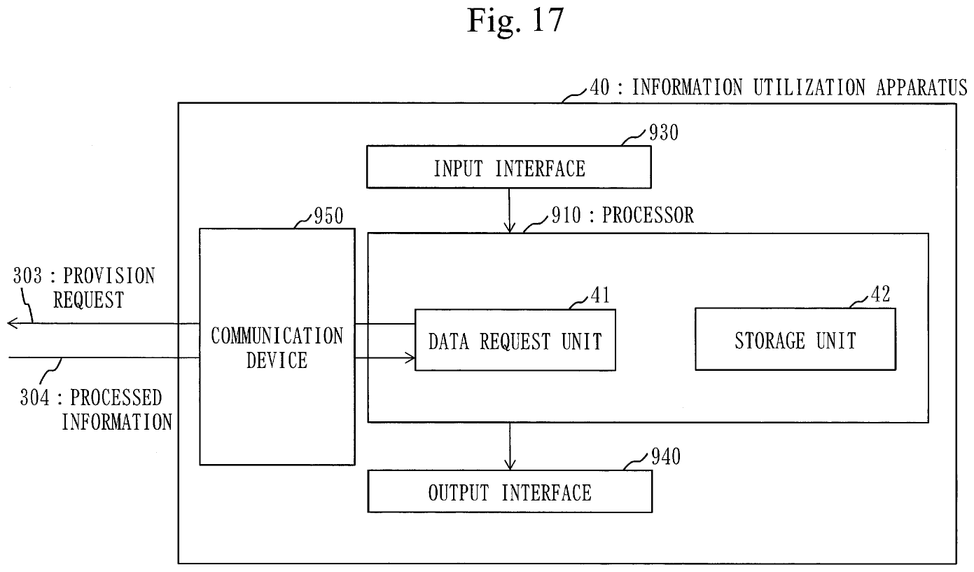

With reference to FIGS. 15 to 17, a configuration of each device of the information providing system 500 according to a modification of the present embodiment, that is, each device of the equipment 20, the information providing apparatus 30, and the information utilization apparatus 40 will be described.

As illustrated in FIGS. 15 to 17, each device of the information providing system 500 includes hardware such as a processing circuit 909, an input interface 930, an output interface 940, and a communication device 950.

The processing circuit 909 is a dedicated electronic circuit for realizing a function of each unit of each device described above, and realizing the storage units 22, 37, and 42 of each device. Specifically, the processing circuit 909 is a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

A function of each unit of each device may be realized by one processing circuit 909, or may be realized by being dispersed to a plurality of processing circuits 909.

As another modification, a function of each unit of each device may be realized by a combination of software and hardware. That is, a part of a function of each device of the information providing system 500 may be realized by dedicated hardware, and the remaining function may be realized by software.

The processor 910, the storage device 920, and the processing circuit 909 of each device of the information providing system 500 are collectively referred to as “processing circuitry”. That is, in any of the configurations illustrated in FIGS. 2 to 4 and FIGS. 15 to 17 being adopted for the configuration of each device of the information providing system 500, a function of each unit of each device and the storage units 22, 37, 42 of each device are realized by the processing circuitry.

The “unit” may be replaced with “step”, “procedure”, or “processing”. Further, a function of “unit” may be realized by firmware.

Description of Effect of Embodiment

According to the information providing system according to the present embodiment, only the processed information processed in accordance with the use permission is provided, and the equipment information as original data is not provided. Therefore, according to the information providing system of the present embodiment, it is possible to prevent non-permitted utilization of the equipment information as original data. Further, according to the information providing system of the present embodiment, it is possible to guarantee that information is securely handled within a range of use permission.

Further, according to the information providing system according to the present embodiment, it is possible to realize a cycle of reconsidering use permission information for equipment information in accordance with a utilization history of the equipment information. Further, according to the information providing system of the present embodiment, the owner of the equipment can safely provide personal information or privacy information and can receive a substantial service, by realizing the cycle of reconsidering the use permission information for the equipment information in accordance with the utilization history of the equipment information.

Further, according to the information providing system according to the present embodiment, since a history is generated by associating a use application and a processing method of equipment information, arrogation of a utilization history can be prevented. Therefore, the service provider can utilize personal information or privacy information without infringing on laws regarding personal information or privacy, and can expand the service providing range.

### Second Embodiment

In the present embodiment, points different from the first embodiment will mainly be described. Configurations having functions similar to those of the first embodiment will be described using the same reference numerals.

In the operation example of the information providing system 500 of FIG. 14 described in the first embodiment, the description has been given to the configuration in the case where the user 60 who is the owner of the household electric appliance provides the information of the household electric appliance to an external data utilization service. In the operation example of the information providing system 500 of FIG. 14, an acquisition target of the use permission for the equipment information 201 is the user 60, and the user 60 provides the processed information 304 to an external data utilization service.

In the present embodiment, description is given to a case where an information providing system 500 performs a disclosure control of logs of business equipment and system. In the present embodiment, equipment 20 as a data collection target is business equipment, and an acquisition target of use permission for the business equipment is a system administrator. In the present embodiment, description is given to an operation example of providing processed information 304 to a person involved within a company, such as person in charge of maintenance of the business equipment.

Equipment information 201 of the business equipment may include confidential information on a user or a utilization site of the business equipment. Therefore, even within a company that manages the business equipment, the system administrator may not want to disclose the equipment information 201 to other than a specific department such as for a maintenance service.

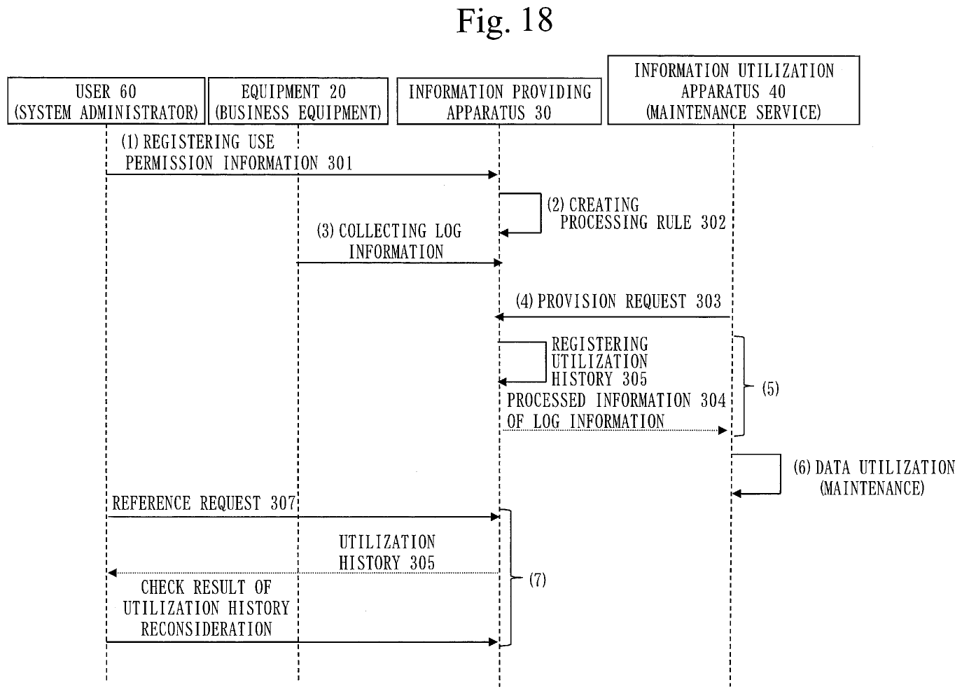

With reference to FIG. 18, an operation example of the information providing system 500 according to the present embodiment will be described. FIG. 18 is a flowchart illustrating a series of operations for acquiring use permission information 301 for the equipment information 201, utilizing the equipment information 201, and reconsidering the use permission, in a case of assuming the specific example described above.

Note that, since the configuration of the information providing system 500 according to the present embodiment is similar to that of the first embodiment, the description thereof is omitted.

In the operation example of FIG. 18, the business equipment is the equipment 20, and a maintenance service of the equipment 20 in another department within the company that manages the business equipment is an information utilization apparatus 40.

(1) An administrator of the equipment 20, that is, a user 60 who is a system administrator, registers the use permission information 301 in an information providing apparatus 30.

(2) The information providing apparatus 30 creates a processing rule 302 from the use permission information 301, and stores. The processing of (1) and (2) corresponds to the processing rule storage process S20 in FIG. 7.

(3) Operation data of the business equipment is transmitted as log information from the business equipment to the information providing apparatus 30 as the equipment information 201, and is stored in the information providing apparatus 30. The processing of (3) corresponds to the equipment information collection process S10 of FIG. 6.

(4) The maintenance service performs provision request for log information, to the information providing apparatus 30.

(5) The information providing apparatus 30 processes the log information, records a utilization history thereof, and returns the processed information 304 of the log information. The processing of (4) and (5) corresponds to the providing process S30 in FIG. 10.

(6) The maintenance service utilizes the processed information 304 of the log information and detects abnormality of the business equipment, thereby performing maintenance work.

(7) Finally, the system administrator checks the utilization history 305 of the log information to the information providing apparatus 30. When there is such a problem that there is utilization contradicting an assumed use permission, the system administrator reconsiders the use permission. The processing of (7) corresponds to the utilization history reference process S40 of FIG. 13.

Thereafter, the information providing system 500 repeats the cycle from (1) to (7).

As described above, according to the information providing system 500 of the present embodiment, it is possible to use for internal control within a company, that is, inside an organization, by applying the information providing system 500 to the disclosure control of logs of the business equipment or system.

In the first and second embodiments, each unit of each device of the information providing system 500 constitutes each device of the information providing system 500 as an independent functional block. However, the configuration is not limited to the above-described embodiment, and each device of the information providing system 500 may have any configuration. As long as the functions described in the above embodiments can be realized, any functional block may be adopted for each device of the information providing system 500. Each device of the information providing system 500 may be configured by using any other combination or any block configuration of these functional blocks.

Further, each device of the information providing system 500 may be a system configured by a plurality of devices instead of a single device.

Although the first and second embodiments have been described, a plurality of parts may be combined and implemented in these embodiments. Alternatively, one part of these embodiments may be implemented. Besides, these embodiments may be implemented entirely or partially in any combination.

It is to be noted that the above-described embodiments are preferable examples in nature, and are not intended to limit the scope of the present invention, its application, and purpose, and various modified examples are possible as necessary.

### REFERENCE SIGNS LIST

20: equipment, 21: data transmission unit, 30: information providing apparatus, 31: equipment information reception unit, 32: permission information acquisition unit, 33: rule generation unit, 34: data provision unit, 35: data processing unit, 36: reference unit, 22, 37, 42: storage unit, 40: information utilization apparatus, 41: data request unit, 50: network, 60: user, 201: equipment information, 301: use permission information, 302: processing rule, 303: provision request, 304: processed information, 305: utilization history, 306: conversion definition, 307: reference request, 321, 333: use application, 322: providing destination, 323, 334: data type, 324, 335: data range, 325: permitted processing method, 326: reference frequency, 330: provision unit, 331: data owner, 332: request source, 336: requested processing method, 371: equipment information storage unit, 372: rule storage unit, 373: history storage unit, 500: information providing system, 610: information providing method, 620: information providing program, 909: processing circuit, 910: processor, 920: storage device, 921: memory, 922: auxiliary storage device, 930: input interface, 940: output interface, 950: communication device, S10: equipment information collection process, S20: rule storage process, S30: providing process, S40: utilization history reference process.

1.-8. (canceled)

9. An information providing apparatus comprising:
processing circuitry
to store a processing rule including, as a permitted processing method, a processing method permitted for equipment information transmitted from equipment, and
to acquire a provision request requesting processing and providing of the equipment information, the provision request including a processing method of the equipment information as a requested processing method, process the equipment information by the requested processing method when the requested processing method matches the permitted processing method included in the processing rule, and transmit the equipment information as processed information to a request source of the provision request.

10. The information providing apparatus according to claim 9,
wherein the processing circuitry
generates a history of transmitting the processed information to the request source of the provision request, as a utilization history, and
stores the generated utilization history.

11. The information providing apparatus according to claim 10,
wherein the processing circuitry
generates a history in which generation of the processed information has been impossible for the provision request, when the requested processing method does not match the permitted processing method included in the processing rule, and
stores the utilization history such that a history in which generation of the processed information has been impossible for the provision request is included in the utilization history.

12. The information providing apparatus according to claim 10, wherein the processing circuitry
acquires a reference request requesting reference to the utilization history, extracts the utilization history based on the reference request, and transmits the extracted utilization history to a request source of the reference request.

13. The information providing apparatus according to claim 11, wherein the processing circuitry
acquires a reference request requesting reference to the utilization history, extracts the utilization history based on the reference request, and transmits the extracted utilization history to a request source of the reference request.

14. The information providing apparatus according to claim 9, wherein the processing circuitry
acquires use permission information indicating a permission condition including a processing method permitted for the equipment information, the permission condition being permitted for the equipment information, and
generates the processing rule based on the use permission information, and stores the processing rule.

15. The information providing apparatus according to claim 10, wherein the processing circuitry
acquires use permission information indicating a permission condition including a processing method permitted for the equipment information, the permission condition being permitted for the equipment information, and
generates the processing rule based on the use permission information, and stores the processing rule.

16. The information providing apparatus according to claim 11, wherein the processing circuitry
acquires use permission information indicating a permission condition including a processing method permitted for the equipment information, the permission condition being permitted for the equipment information, and
generates the processing rule based on the use permission information, and stores the processing rule.

17. An information providing system comprising:
equipment including processing circuitry to transmit equipment information;
an information utilization apparatus to utilize the equipment information, the information utilization apparatus including processing circuitry to transmit a provision request requesting provision of the equipment information; and
an information providing apparatus to receive the equipment information from the equipment, and receive the provision request from the information utilization apparatus,
wherein the information providing apparatus
includes processing circuitry to store a processing rule including, as a permitted processing method, a processing method permitted for the equipment information,
wherein the processing circuitry of the information utilization apparatus
transmits, to the information providing apparatus, the provision request requesting processing and providing of the equipment information, the provision request including a processing method of the equipment information as a requested processing method, and
wherein the processing circuitry of the information providing apparatus
receives the provision request, processes the equipment information by the requested processing method when the requested processing method included in the provision request matches the permitted processing method included in the processing rule, and transmits the equipment information as processed information to a request source of the provision request.

18. An information providing method comprising:
storing a processing rule including, as a permitted processing method, a processing method permitted for equipment information transmitted from equipment; and
acquiring a provision request requesting processing and providing of the equipment information, the provision request including a processing method of the equipment information as a requested processing method, processing the equipment information by the requested processing method when the requested processing method matches the permitted processing method included in the processing rule, and transmitting the equipment information as processed information to a request source of the provision request.

19. A non-transitory computer readable medium storing an information providing program for causing a computer to execute:
a rule storage process of storing a processing rule including, as a permitted processing method, a processing method permitted for equipment information transmitted from equipment; and
a providing process of acquiring a provision request requesting processing and providing of the equipment information, the provision request including a processing method of the equipment information as a requested processing method, processing the equipment information by the requested processing method when the requested processing method matches the permitted processing method included in the processing rule, and transmitting the equipment information as processed information to a request source of the provision request.
